(19) United States
(12) Patent Application Publication
(10) Pub. No.: US 2012/0169088 A1
(43) Pub. Date: Jul. 5, 2012

(54) Vehicle Suspension System

(76) Inventor: Udo Scheff, Worms (DE)

(21) Appl. No.: 13/256,008

(22) PCT Filed: Mar. 5, 2010
(86) PCT No.: PCT/EP10/52828

§ 371 Date: Nov. 21, 2011

(30) Foreign Application Priority Data
Mar. 13, 2009 (DE) 10 2009 001 546.9

(51) Int. Cl. B60G 15/12

(52) U.S. Cl. 296/190.07

(57) ABSTRACT

A suspension system for a motor vehicle includes a spring cylinder for movably mounting a cab or a driver's seat relative to a body part of the vehicle. The spring cylinder is connected to a separation accumulator which holds a smart damping fluid. The separation accumulator is connected to a hydraulic accumulator by a throttle element which is coupled to an adapting device which adjusts a characteristic of the smart damping fluid.

The invention relates to a suspension device for a motor vehicle. The suspension device comprises a spring cylinder for the vibration-isolating mounting of a vehicle component, in particular a driver's cab or a driver's seat, which is arranged so as to be movable relative to a body part of the motor vehicle. The vehicle is preferably an agricultural utility vehicle, for example a tractor, a self-propelled spraying machine, a harvester or the like.

A suspension device of said type in the form of a wheel suspension for a motor vehicle is known from the patent DE 28 07 299 C2. The wheel suspension comprises a pressure medium cylinder which is articulately connected between an axle body and a body of the motor vehicle, the piston chamber of which pressure medium cylinder is connected at one side via a 3/3 directional control valve to a pressure medium pump and at the other side via a shut-off valve, which permits blocking of the pressure medium cylinder, to a hydropneumatic accumulator. Furthermore, a throttle element is provided which is mechanically adjustable with regard to its flow resistance and which connects the annular chamber of the pressure medium cylinder to a pressure medium collecting tank of the motor vehicle, in such a way that vibration damping is realized with a variable or adaptable damping characteristic.

Since the throttle element is adjusted mechanically, that is to say the speed of adaptation of the damping characteristic is limited by the mass inertia of the mechanical adjusting elements used, the known suspension device is suitable at best for damping low-frequency vibrations such as are characteristic of the chassis of an agricultural utility vehicle.

It is therefore an object of the present invention to specify a suspension device which is improved with regard to the speed of adaptation of the damping characteristic.

Said object is achieved according to the features of patent claim 1.

The suspension device for a motor vehicle comprises a spring cylinder for the vibration-isolating mounting of a vehicle component which is arranged so as to be movable relative to a body part of the motor vehicle, wherein the vehicle component is in particular a driver's cab or a driver's seat. According to the invention, the spring cylinder is connected to a separating accumulator for the indirect pressurization of a rheologically variable damping fluid situated in the separating accumulator. The rheologically variable damping fluid situated in the separating accumulator acts via a throttle element on a hydraulic accumulator, which is connected to the separating accumulator, in such a way that the damping characteristic of the spring cylinder can be adapted by means of a device for rheological variation.

Since the variation of the flow resistance of the throttle element is realized by varying the rheological properties and therefore the flow behavior of the damping fluid, and not for example by means of a mechanical adjustment of the throttle element, the suspension device according to the invention permits a particularly rapid adaptation of the damping characteristic. The suspension device according to the invention is therefore also suitable for damping relatively high-frequency vibrations such as occur in the case of lightweight vehicle components, for example a driver's seat or a driver's cab. On account of the lack of mechanical adjusting elements, the adaptation of the damping characteristic furthermore takes place substantially without wear.

Since the spring cylinder only indirectly pressurizes the damping fluid situated in the separating accumulator, that is to say there is fluidic separation between an operating fluid provided for the operation of the spring cylinder and the damping fluid, the spring cylinder itself may be of conventional design. The damping fluid which is pressurized by means of the separating accumulator in the event of a deflection of the spring cylinder flows through the throttle element and determines, according to the flow resistance thereof, the damping characteristic of the suspension device. More precisely, the damping fluid forms a fluidic volume which is situated between the separating accumulator and the hydraulic accumulator and which, in a manner corresponding to the deflection of the spring cylinder counter to a restoring force imparted by the hydraulic accumulator, is carried along and thereby caused to flow through the throttle element.

Advantageous embodiments of the suspension device according to the invention emerge from the subclaims.

The damping fluid is preferably a magnetorheological liquid or an electrorheological liquid. The composition and the behavior of such liquids are described in technical literature.

Accordingly, magnetorheological or electrorheological liquids respectively have magnetically or electrically polarized particles which are colloidally suspended in a carrier liquid, typically mineral oil or synthetic oil.

In the case of magnetorheological liquids, the particles are conventionally composed of carbonyl iron with a diameter of 1 to 10 μm. The particles are generally stabilized by means of a polymeric surface coating in order to eliminate an undesired sedimentation tendency. If the magnetorheological liquid is exposed to a magnetic field, the particles within the carrier liquid concatenate along the field lines and lead to an increase, which is dependent on the field strength, of the shear yield point. In this way, the flow behavior of the magnetorheological liquid can be reversibly changed within a few milliseconds.

Electrorheological liquids behave in a similar way. In contrast to magnetorheological fluids, these are composed of non-conductive particles with a diameter of up to 50 μm, preferably composed of starch or a conductive material with an insulating coating. In the latter case, an increased dielectric constant and therefore an intensification of the electrorheological effect is obtained. If the electrorheological liquid is exposed to an electric field, then the particles within the carrier liquid concatenate along the field lines, similarly to the behavior of the magnetorheological liquid.

The rheological variation of the damping fluid preferably takes place in the region of a passage duct which determines the flow resistance of the throttle element. By correspondingly predefining the geometry of the passage duct and the rheological properties of the damping fluid used, a specific adaptation of the damping characteristic of the suspension device is possible. The passage duct may for example take the form of a taper or constriction formed in the throttle element.

A particularly high flow resistance may be attained if, by means of the device for rheological variation, a magnetic field or electric field can be generated which is oriented substantially perpendicular to the profile of the passage duct, and therefore to the concatenation direction of the particles in the magnetorheological or electrorheological liquid.

The device for rheological variation may in particular be a magnet coil arrangement formed as a structural constituent part of the magnet coil arrangement. The magnet coil arrangement comprises for example a magnet coil wound around a ferromagnetic core. The magnet coil and/or the ferromagnetic core opens into the throttle element preferably in the direct vicinity of the passage duct. The magnetic field typically has a field strength of the order of magnitude of between 0 and 350 mT in the region of the passage duct.

It is alternatively possible for the device for rheological variation to be an electrode arrangement formed as a structural constituent part of the throttle element. The electrode arrangement may in particular comprise a pair of electrodes which are spaced apart from one another. The electrode pair directly borders or surrounds the passage duct formed in the throttle element. It is conceivable here for the electrodes to be provided with a coating of electrically polarizable insulation material. This leads to a reduction in possible leakage currents in the electrorheological liquid. The electric field typically has a field strength of the order of magnitude of between 0 and 5 kV/mm in the region of the passage duct.

A control device serves to activate the magnet coil arrangement or the electrode arrangement. The activation may take place on the basis of state variables which characterize the movement behavior of the vehicle component arranged so as to be movable relative to the body part of the motor vehicle. The state variables may in particular be a position variable which is determined by means of suitable sensors and which represents a present position of the vehicle component relative to the supporting body part, and/or a derivative of the determined position variable with respect to time. The activation of the magnet coil arrangement or of the electrode arrangement takes place by means of an electrical current source or high-voltage source which interacts with the control device.

For the indirect pressurization of the damping fluid, the separating accumulator comprises a pressure vessel which is divided by a separating element, which is flexible under pressure, into a first and second working chamber. The first working chamber is connected to the spring cylinder and the second working chamber is connected to the hydraulic accumulator via the throttle element. The separating accumulator is preferably designed as a diaphragm accumulator. The separating element which is flexible under pressure may in this case be an elastic diaphragm composed of a suitable rubber mixture, an elastomer bladder or a metal bellows. It is however also conceivable for a separating accumulator with a piston movably mounted therein to be provided instead of a diaphragm accumulator.

The hydraulic accumulator may be designed similarly to the separating accumulator. Accordingly, the hydraulic accumulator itself comprises a pressure vessel divided by a separating element, which is flexible under pressure, into a first and a second working chamber. The first working chamber is connected to the separating accumulator via the throttle element, whereas a pressurized gas situated in the second working chamber forms a gas spring which acts on the separating element. The gas is generally nitrogen or a gaseous nitrogen compound. Alternatively, the hydraulic accumulator may also be designed as a spring-loaded accumulator in which a mechanically preloaded spring element instead of a gas acts on the separating element.

If the spring cylinder is deflected out of its rest position, a pressure increase or pressure drop, which is dependent on the direction and extent of the deflection, is generated in the operating fluid situated in the first working chamber of the separating accumulator, which pressure increase or pressure drop results in flexing of the separating element. This ultimately leads to a corresponding pressure increase or pressure drop in the damping fluid situated in the second working chamber, as a result of which said damping fluid is caused to flow through the throttle element counter to the restoring spring force of the hydraulic accumulator.

The spring cylinder itself may be of conventional design. It may in particular be a hydraulically or pneumatically operated spring cylinder which is divided by means of a movably mounted piston into an annular chamber and a piston chamber. A passage formed in the piston produces a fluidic connection between the annular chamber and the piston chamber. The passage simultaneously forms a throttle element for an operating fluid which flows through in the event of a deflection of the piston. If the piston chamber is pressurized by means of a supply of operating fluid, the pressure-active cross-sectional area of the piston chamber, which is larger than that of the annular chamber, leads to a deployment of the piston in the spring cylinder.

The spring cylinder is preferably connected to a hydraulic or pneumatic pressure medium supply arranged in the motor vehicle. To be able to vary the rest position of the vehicle component which is arranged so as to be movable relative to the body part of the motor vehicle, it is advantageous for the pressure medium supply to be a constituent part of a level control system of the motor vehicle. The level control system may in particular be manually controlled by means of an operating device arranged in the motor vehicle.

Specifically if servicing work has not been carried out professionally, it is possible for damping fluid to pass into the operating fluid situated in the spring cylinder and from there into the pressure medium supply of the motor vehicle. To prevent possible functional impairment of the pressure medium supply on account of the particles in the damping fluid, it is advantageous for a suitable filter element to be arranged between the pressure medium supply and the spring cylinder. The filter element is for example a microporous ceramic filter with a pore size in the range of a few μm.

The suspension device according to the invention for a motor vehicle will be explained in more detail below on the basis of the appended drawings. Here, components which correspond or are similar with regard to their function are denoted by the same reference numerals. In the drawings:

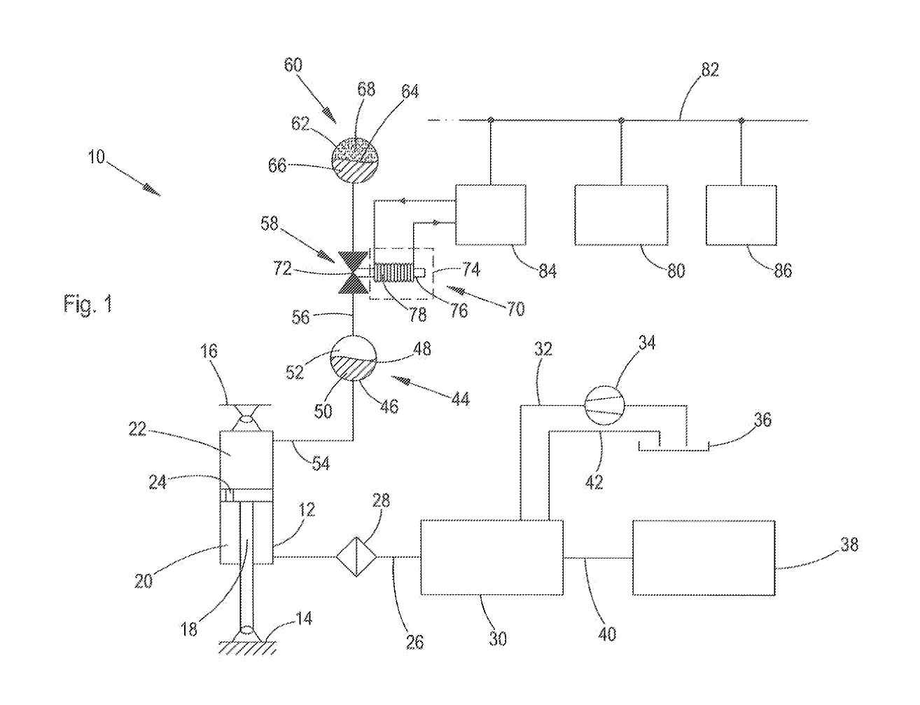

FIG. 1 shows a first exemplary embodiment of the suspension device according to the invention for a motor vehicle, and

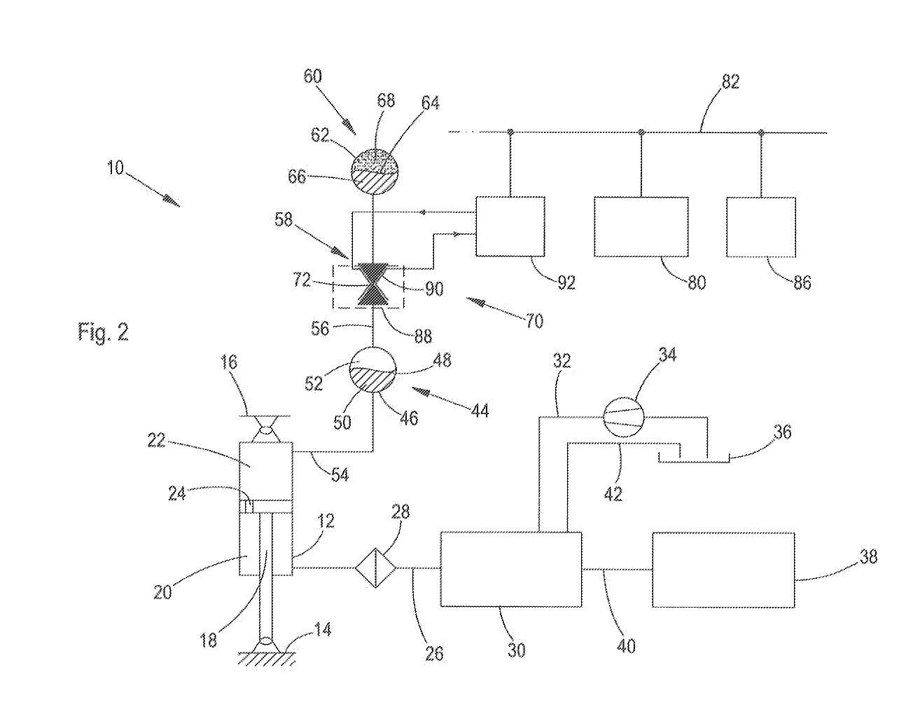

FIG. 2 shows a second exemplary embodiment of the suspension device according to the invention for a motor vehicle.

FIG. 1 shows a first exemplary embodiment of the suspension device according to the invention for a motor vehicle (not illustrated), in particular for an agricultural utility vehicle in the form of a tractor, a self-propelling spraying machine, a harvester or the like.

The suspension device 10 comprises a spring cylinder 12 for the vibration-isolating mounting of a vehicle component 16 which is arranged so as to be movable with respect to a body part 14 of the motor vehicle. The vehicle component 16 is for example a driver's seat or a drivers' cab.

The hydraulically or pneumatically operated spring cylinder 12 is divided by means of a movably mounted piston 18 into an annular chamber 20 and a piston chamber 22. Here, the piston 18 is sealed off with respect to a cylindrical inner wall of the spring cylinder 12. A passage 24 formed in the piston 18 produces a fluidic connection between the annular chamber 20 and the piston chamber 22. The passage 24 simultaneously forms a throttle element for an operating fluid which flows through in the event of a deflection of the piston 18. The operating fluid is for example compressed air or a hydraulic liquid.

For the operation of the suspension device 10, the spring cylinder 12 is connected via a supply line 26, and via a filter element 28 which is arranged in said supply line and which takes the form of a microporous ceramic filter, to a pressure medium supply 30 situated in the motor vehicle. The pressure medium supply 30 is fed with operating fluid from a reservoir 36 of the motor vehicle via a pressure feed line 32 by means of a high-pressure pump 34. If the piston chamber 22, which is connected to the pressure medium supply 30 via the supply line 26, of the spring cylinder 12 is pressurized by means of a supply of operating fluid, the pressure-active cross-sectional area of the piston chamber 22, which is larger than that of the annular chamber 20, leads to a deployment of the piston 18 in the spring cylinder 12. A variation in the rest position of the vehicle component 16 in relation to the supporting body part 14 is possible in this way.

For the variation of the rest position of the vehicle component 16, the pressure medium supply 30 is a constituent part of a level control system 38 of the motor vehicle. The level control system 38 activates the pressure medium supply 30 via an electric control line 40 such that the pressure provided for the operation of the spring cylinder 12 can be varied. The pressure medium supply 30 may for this purpose have an electromagnetic pressure control valve which can be connected to the high-pressure pump 34 or via a pressure discharge line 42 to the reservoir 36. Here, the level control system 38 may be controlled manually by means of an operating device arranged in the motor vehicle.

In the first exemplary embodiment illustrated in FIG. 1, the spring cylinder 12 is connected to a separating accumulator 44 for the indirect pressurization of a rheologically variable damping fluid situated in the separating accumulator 44. The separating accumulator 44 comprises a pressure vessel 46 which is divided by a separating element 48, which is flexible under pressure, into a first working chamber 50 and a second working chamber 52. Here, the first working chamber 50 is connected via a first line section 54 to the piston chamber 22 of the spring cylinder 12 and the second working chamber 52 is connected via a second line section 56, and via a throttle element 58 arranged in said second line section, to a hydraulic accumulator 60.

The separating accumulator 44 is designed, in the example, as a diaphragm accumulator. The separating element 48, which is flexible under pressure, is in this case an elastic diaphragm composed of a suitable rubber mixture, an elastomer bladder or a metal bellows. During the operation of the suspension device 10, the spring cylinder 12, the first line section 54 and the first working chamber 50, which is connected to said first line section, of the separating accumulator 44 are completely filled with operating fluid.

The hydraulic accumulator 60 is of corresponding design to the separating accumulator 44. Accordingly, the hydraulic accumulator 60 comprises a pressure vessel 62 which is divided by a separating element 64, which is flexible under pressure, into a first working chamber 66 and a second working chamber 68. The first working chamber 66 is connected via the second line section 56, and via the throttle element 58 arranged in said second line section, to the second working chamber 52 of the separating accumulator 44, whereas a pressurized gas situated in the second working chamber 68 of the hydraulic accumulator 60 forms a gas spring which acts on the separating element 64. The gas is preferably nitrogen or a gaseous nitrogen compound. During the operation of the suspension device 10, the second working chamber 52 of the separating accumulator 44, the second line section 56 and the first working chamber 66, which is connected to said second line section, of the hydraulic accumulator 60 are completely filled with damping fluid.

If the spring cylinder 12 or the piston 18 movably mounted therein is deflected out of its rest position, a pressure increase or pressure drop is generated in the operating fluid situated in the first working chamber 50 of the separating accumulator 44, which pressure increase or pressure drop results in flexing of the separating element 48. This ultimately leads to a corresponding pressure increase or pressure drop in the damping fluid situated in the second working chamber 52, said damping fluid being caused to flow through the throttle element 58 counter to the restoring spring force of the hydraulic accumulator 60. Here, the flow resistance in the throttle element 58 determines the damping characteristic of the spring cylinder 12.

For the adaptation of the damping characteristic of the spring cylinder 12, the damping fluid can be varied with regard to its rheological properties, and therefore its flow behavior, by means of a device for rheological variation 70. The rheological variation takes place in the region of a passage duct 72 which determines the flow resistance of the throttle element 58. In the example, the passage duct 72 takes the form of a taper or construction formed in the throttle element 58.

In general terms, the rheologically variable damping fluid situated in the separating accumulator 44 thus acts via the throttle element 58 on a hydraulic accumulator 60 which is connected to the separating accumulator 44, in such a way that the damping characteristic of the spring cylinder 12 can be adapted by means of the device for rheological variation 70.

In the present case, the damping fluid is a magnetorheological liquid and the device for rheological variation 70 is a magnet coil arrangement 74 formed as a structural constituent part of the throttle element 58. The magnet coil arrangement 74 comprises a magnet coil 78 wound around a ferromagnetic core 76. The magnet coil 78 or the ferromagnetic core open into the throttle element 58 in the direct vicinity of the passage duct 72, specifically in such a way that the magnetic field generated is oriented substantially perpendicular to the profile of the passage duct 72. The magnetic field typically has a field strength of the order of magnitude of between 0 and 350 mT in the region of the passage duct 72.

A control device 80, or an electrical current source 84 which interacts with said control device via a CAN data bus 82, serves for electrically activating the magnet coil arrangement 74. The activation takes place on the basis of state variables which characterize the movement behavior of the vehicle component 16 which is mounted so as to be movable relative to the body part 14 of the motor vehicle. The state variables encompass a position variable which is determined by means of position and/or acceleration sensors 86 and which represents a present position of the vehicle component 16 relative to the supporting body part 14, and/or a derivative of the determined position variable with respect to time. If an increasing vibration tendency of the vehicle component 16 is inferred by the control device 80 from an evaluation of the state variables, the control device 80 adapts the damping characteristic of the spring cylinder 12 by correspondingly increasing the electrical current flowing through the magnet coil and therefore the field strength of the magnetic field generated in the region of the passage duct 72 of the throttle element 58 by means of the magnet coil arrangement 74.

FIG. 2 shows a second exemplary embodiment of the suspension device according to the invention for a motor vehicle.

The second exemplary embodiment differs from the first exemplary embodiment illustrated in FIG. 1, while otherwise functioning in the same way, in that the damping fluid is an electrorheological liquid and the device for rheological variation 70 is an electrode arrangement 88 formed as a structural constituent part of the throttle element 58. The electrode arrangement 88, which is coated in an electrically polarizable insulation material, comprises a pair of electrodes 90 spaced apart from one another. The control device 80 or a high-voltage source 92 which interacts therewith serves to electrically activate the electrode arrangement 88. Here, the electrode pair 90 directly borders or surrounds the passage duct 72 formed in the throttle element 58, specifically in such a way that the electric field generated is oriented substantially perpendicular to the profile of the passage duct 72. The electric field generated by means of the electrode arrangement 88 typically has a field strength of the order of magnitude of between 0 and 5 kV/mm in the region of the passage duct 72.

We claim:

1. A suspension system for a motor vehicle, having a spring cylinder for the vibration-isolating mounting of a vehicle component which is movable relative to a body part of the motor vehicle, characterized by:
a separating accumulator connected to the spring cylinder;
a hydraulic accumulator, the separating accumulator and the hydraulic accumulator containing a smart damping fluid, the spring cylinder indirectly pressurizing the smart damping fluid in the separating accumulator;
a throttle element communicating the smart fluid between the separating accumulator and the hydraulic accumulator; and
an adapting device for varying a property of the smart fluid.

2. The suspension system of claim 1, wherein:
the smart damping fluid is a magnetorheological liquid.

3. The suspension system of claim 2, wherein:
the throttle element includes a passage duct, and the adapting device generates a magnetic field near the passage duct.

4. The suspension system of claim 3, wherein:
the magnetic field is oriented substantially perpendicular to a profile of the passage duct.

5. The suspension system of claim 3, wherein:
the adapting device comprises is a magnet coil arrangement formed as a structural constituent part of the throttle element.

6. The suspension system of claim 1, wherein:
the separating accumulator is a diaphragm accumulator.

7. The suspension system of claim 1, wherein:
the spring cylinder is connected to a fluid supply arranged in the motor vehicle.

8. The suspension system of claim 7, wherein:
the fluid supply is part of a level control system.

9. The suspension system of claim 7, wherein:
a particle filter is arranged between the fluid supply and the spring cylinder.

10. The suspension system of claim 1, wherein:
the smart damping fluid is an electrorheological liquid.

11. The suspension system of claim 10, wherein:
the throttle element includes a passage duct, and the adapting device generates an electric field near the passage duct.

12. The suspension system of claim 11, wherein:
the electric field is oriented substantially perpendicular to a profile of the passage duct.
